(19) United States
(12) Patent Application Publication
(10) Pub. No.: US 2026/0065651 A1
(43) Pub. Date: Mar. 5, 2026

(54) METHOD, DEVICE, AND STORAGE MEDIUM FOR IMAGE GENERATION

(71) Applicant: Beijing Zitiao Network Technology Co., Ltd., Haidian District (CN)

(72) Inventors: Jie Wu, Beijing (CN); Xuefeng Xiao, Beijing (CN)

(21) Appl. No.: 19/293,368

(22) Filed: Aug. 7, 2025

(30) Foreign Application Priority Data
Aug. 28, 2024 (CN) 202411194834.0

(51) Int. Cl. G06V 10/774; G06F 40/58; G06T 11/00

(52) U.S. Cl. CPC G06V 10/774; G06F 40/58; G06T 11/00

(57) ABSTRACT

The embodiment of the invention provides a method and device for image generation, equipment and a storage medium. The method includes obtaining a reference text set indicating an image generation objective, the reference text set including text in multiple languages. Generating at least one reference image based on the first text in the first language in the reference text set by using the image generation model. The first text is converted to a second text in the second language, the second language being different from the first language. The reward model is trained based on the first text, the second text, the at least one reference image, and the labeled information for the at least one reference image, the labeled information indicates an image quality of the at least one reference image, and the reward model is configured to fine tune the image generation model.

### CROSS-REFERENCE TO RELATED APPLICATIONS

The present application claims priority to Chinese Patent Application No. 202411194834.0, filed on August 28, 2024 and entitled “METHOD, APPARATUS, DEVICE, AND STORAGE MEDIUM FOR IMAGE GENERATION”, the entirety of which is incorporated herein by reference.

### FIELD

Example embodiments of the present disclosure generally relate to the field of computers, and in particular, to a method, a device, and a computer-readable storage medium for image generation.

### BACKGROUND

In the field of computer vision (CV), various image processing techniques based on machine learning have been developed significantly and have wide application. For example, images with some visual effect (e.g., effects or filters) are desired to be generated and used in many application scenarios such as social, gaming, image editing, and the like. Image generation techniques based on machine learning may be used in such application scenarios to improve user experience. In some example application scenarios, it is desirable to generate an image that matches the user input based on user input information, such as text description information.

### SUMMARY

In a first aspect of the present disclosure, a method for image generation is provided. The method includes: obtaining a reference text set indicating an image generation objective, the reference text set comprising texts in a plurality of languages; generating at least one reference image based on a first text in a first language in the reference text set with an image generation model; converting the first text to a second text in a second language, the second language being different from the first language; and training a reward model based on the first text, the second text, the at least one reference image and labeled information for the at least one reference image, the labeled information indicating an image quality of the at least one reference image, and the reward model being configured to fine tuning the image generation model..

In a second aspect of the present disclosure, an apparatus for image generation is provided. The apparatus includes: an obtaining module configured for obtaining a reference text set indicating an image generation objective, the reference text set comprising texts in a plurality of languages; a generation module configured for generating at least one reference image based on a first text in a first language in the reference text set with an image generation model; a converting module configured for converting the first text to a second text in a second language, the second language being different from the first language; and a training module configured fortraining a reward model based on the first text, the second text, the at least one reference image and labeled information for the at least one reference image, the labeled information indicating an image quality of the at least one reference image, and the reward model being configured to fine tuning the image generation model..

In a third aspect of the present disclosure, an electronic device is provided. The apparatus includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium have a computer program stored thereon, and the computer program is executable by the processor to implement the method of the first aspect.

It may be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIG. 2 illustrates an architecture diagram of an example of a reward model training system according to some embodiments of the present disclosure;

FIG. 3 illustrates an architecture diagram of an example of a reference text set acquisition system according to some embodiments of the present disclosure;

FIG. 4 illustrates an architecture diagram of an example of an labeled information acquisition system according to some embodiments of the present disclosure;

FIG. 5 is an architecture diagram of an example of an image generation model training unit according to some embodiments of the present disclosure;

FIG. 6 shows a flowchart of a process for image generation according to some embodiments of the present disclosure;

FIG. 7 shows a block diagram of an apparatus for image generation according to some embodiments of the present disclosure; and

FIG. 8 illustrates a block diagram of a device capable of implementing various embodiments of the present disclosure.

### DETAILED DESCRIPTION

It can be understood that, before the technical solutions disclosed in the embodiments of the present disclosure are used, the types of personal information related to the present disclosure, the usage scope, the usage scenario and the like may be notified to the user in an appropriate manner according to the relevant laws and regulations and obtain the authorization of the user.

For example, in response to receiving an active request from a user, prompt information is sent to the user to explicitly prompt the user that the requested operation will need to acquire and use the personal information of the user. Therefore, the user can autonomously select whether to provide personal information to software or hardware (including an electronic device, an application program, a server, a storage medium, and/or the like) executing the operation of the technical solution of the present disclosure according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

It may be understood that the data involved in the technical solution (including but not limited to the data itself, the acquisition or use of the data) may follow the requirements of the corresponding laws and regulations and related regulations.

Embodiments of the present disclosure will be described in more detail below with reference to the accompanying drawings. While certain embodiments of the present disclosure are shown in the accompanying drawings, it is be understood that the present disclosure may be implemented in various forms, and may not be construed as limited to the embodiments set forth herein, but rather, these embodiments are provided for a more thorough and complete understanding of the present disclosure. It is be understood that the drawings and embodiments of the present disclosure are for exemplary purposes only and are not intended to limit the scope of the present disclosure.

It is to be noted that the title of any section / subsection provided herein is not limiting. Various embodiments are described throughout and any type of embodiments may be included in any section / subsection. Furthermore, the embodiments described in any section / subsection may be combined in any manner with the same section / subsection and / or any other embodiment described in different sections / subsections.

Herein, unless explicitly stated, “responding to A” performing one step does not imply that this step is performed immediately after “A”, but may include one or more intermediate steps.

In the description of the embodiments of the present disclosure, the terms “including” and the like may be understood to include “including but not limited to”. The term “based on” may be understood as “based at least in part on”. The terms “one embodiment” or “the embodiment” may be understood as “at least one embodiment”. The term “some embodiments” may be understood as “at least some embodiments”. Other explicit and implicit definitions may also be included below. The terms “first,” “second,” and the like may refer to different or identical objects. Other explicit and implicit definitions may also be included below.

As used herein, the term “model” may learn associations between respective inputs and outputs from training data such that corresponding outputs may be generated for a given input after training is complete. The generation of the model may be based on machine learning techniques. Deep learning is a machine learning algorithm that processes inputs and provides corresponding outputs by using a multi-layer processor. “Model” may also be referred to herein as a “machine learning model,” “machine learning network,” or “network,” which terms are used interchangeably herein. A model may in turn include different types of processors or networks.

As used herein, a “unit,” an “operating unit,” or a “subunit” may be composed of a machine learning model or network of any suitable structure. As used herein, a set of elements or similar expressions may include one or more such elements. For example, a “set of convolution units” may include one or more convolution units.

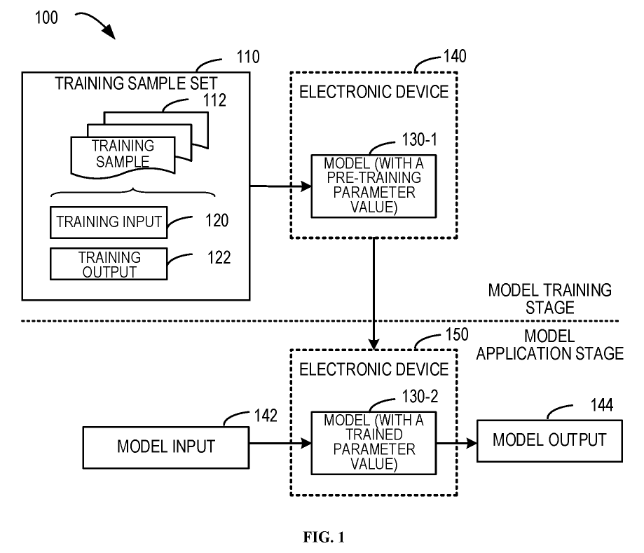

FIG. 1 illustrates a schematic diagram of an example environment 100 in which embodiments of the present disclosure can be implemented. As shown in FIG. 1, a model 130-1 with a pre-training parameter value and a model 130-2 with a trained parameter value may be collectively or individually referred to as a model 130. The model 130 may be included in the electronic device 140 and / or the electronic device 150.

In environment 100 of FIG. 1, it is desirable to train and use such a machine learning model (i.e., the model 130) configured for a variety of application environments. For example, if the model is an image generation model, an image corresponding to a text instruction may be generated based on the text instruction input by the user.

As shown in FIG. 1, the environment 100 includes an electronic device 140 and an electronic device 150. There may be a model training system in the electronic device 140, and there may be a model application system in the electronic device 150. The upper part of FIG. 1 shows a process of a model training phase, and the lower part shows a process of a model application phase. Before training, the parameter values of the model 130 may have an initial value, or may have a parameter value obtained through a pre-training process. The model 130-1 may be trained via forward propagation and backpropagation, where the parameter values of the model 130-1 may be updated and adjusted. Model 130-2 may be obtained after training is complete. The training of the model may in turn include pre-training and fine tuning. Through pre-training, the model 130-1 has a generalization capability, for example, a capability of processing an image by using an input text instruction. Then, in the fine tuning stage, fine tuning is performed on the pre-trained model 130-1 for an image generation task in the downstream. At this point, the parameter values of the model 130-2 have been updated, and based on the updated parameter values, the model 130-2 may be used to implement image processing tasks, such as image generation tasks, in the model application stage.

During the fine tuning stage of model training, the model 130 may be trained based on the training sample set 110 including the plurality of training samples 112 with the model training system. Here, each training sample 112 may relate to a binary tuple format. For example, for an image generation task, the training sample 112 may include a training input 120 and a training output in an image generation task. The training input in the image generation task may include, for example, a training text and an image corresponding to the training audio. Training samples 112 including model inputs 120 and model outputs 122 may be used to train model 130. Specifically, the training process may be iteratively performed by using a large number of training samples. After the training is complete, the model 130 may include knowledge about the image generation task. In the model application stage, the model 130 (the model 130 at this time has a trained parameter value) may be used to perform a corresponding task. For example, a model input 142 in an image generation task may be received and a corresponding model output 144 is output.

In FIG. 1, the electronic device 140 and the electronic device 150 may include any computing system with computing capability, such as various computing devices / systems, terminal devices, servers, and the like. The terminal device may relate to any type of mobile terminal, fixed terminal, or portable terminal, including a mobile phone, a desktop computer, a laptop computer, a notebook computer, a netbook computer, a tablet computer, a media computer, a multimedia tablet, or any combination thereof, including accessories and peripherals of these devices, or any combination thereof. The servers include, but are not limited to, mainframes, edge computing nodes, computing devices in a cloud environment, and the like.

It is to be understood that the components and arrangements in the environment 100 shown in FIG. 1 are merely examples, and that the computing system suitable for implementing the exemplary implementations described in this disclosure may include one or more different components, other components, and / or different arrangements. Implementations of the present disclosure are not limited in this respect. Embodiments of the present disclosure mainly relate to a training phase of an image generation model.

As briefly mentioned above, machine learning techniques have been applied to image generation scenarios. The image generation model generates an image required by the user according to the text input by the user.

Conventionally, in order to match the image generated by the image generation model with the text input by the user to satisfy requirements of the user, the image generation model needs to be trained. One common training solution is to perform human feedback fine tuning on the image generation model by using a reward model. However, most of existing reward models for fine tuning the image generation models support only certain specific languages (e.g., English). If the input text is not in a specific type of language, the reward model cannot well understand the input text, which will affect the training effect of the image generation model.

Embodiments of the present disclosure provide a solution for image generation. According to various embodiments of the present disclosure, a reference text set indicating an image generation objective is obtained, and the reference text set includes text in a plurality of languages. At least one reference image is generated based on a first text in a first language in the reference text set by using an image generation model. The first text is converted to a second text in a second language, the second language being different from the first language. A reward model is trained based on the first text, the second text, the at least one reference image, and the labeled information for the at least one reference image. The labeled information indicates an image quality of the at least one reference image, and the reward model is configured for fine tuning the image generation model.

In this way, the reward model is trained based on the first text and the second text in different languages and the reference image and the labeled information for the reference image, so that the reward model can learn a relationship between different languages and images. Further, fine tuning the image generation model by using the reward model can improve the performance of the image generation model.

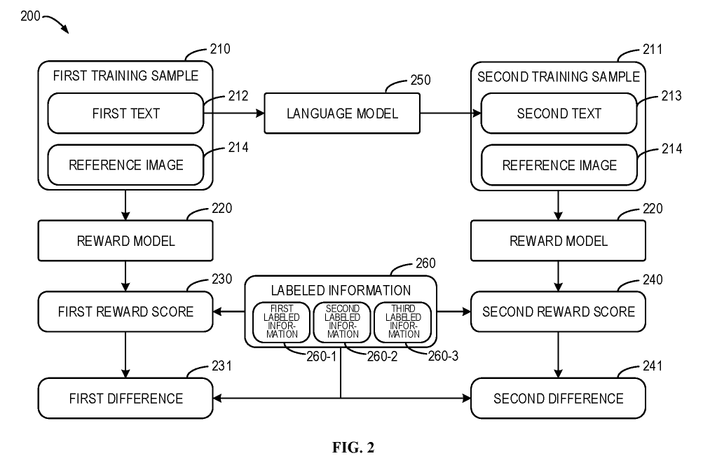

FIG. 2 illustrates an architecture diagram of an example of a reward model training system 200 according to some embodiments of the present disclosure. As shown in FIG. 2, reward model training system 200 may be implemented or included in electronic device 140.

In some embodiments, the electronic device obtains a reference text set indicating an image generation objective. The reference text set includes texts in a plurality of languages. Such texts may be used to describe an image that needs to be generated, e.g., “generate an image that includes a white dog”.

In some embodiments, the electronic device generates the initial text set based on the texts of a plurality of languages related to image generation. Subsequently, the electronic device determines one or more clusters by performing clustering on the texts in the initial text set, each cluster including at least one text. The text is selected from the initial text set based on the one or more clusters to add to the reference text set.

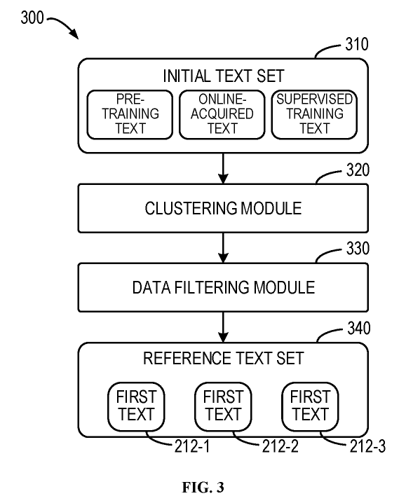

FIG. 3 illustrates an architecture diagram of an example of a text set acquisition system 300 according to some embodiments of the present disclosure. In some embodiments, the reference text set 340 includes a plurality of input texts for training the reward model 220. As shown in FIG. 3, the reference text set 340 includes at least a first text 212-1, a first text 212-2, and a first text 212-3, which may be separately or collectively referred to as the first text 212. The reference text set 340 may include text in a plurality of languages, for example, Chinese texts and English texts. The number of the first text 212 and the language of the first text 212 included in the reference text set 340 are not limited herein.

As shown in FIG. 3, the electronic device constructs an initial data set based on a pre-training text, an online-acquired text, and a supervised training text used in a process such as a model pre-training process, a supervised training process, and/or the like. In some embodiments, invalid data (e.g., duplicate data) in the initial set of data may also be deleted by filtering operations.

Subsequently, the clustering operation is performed on the initial text set 310 by a clustering module 320. The clustering module 320 may be implemented based on a clustering algorithm, for example, the clustering module 320 is implemented based on a k-nearest neighbor (KNN) clustering algorithm. The clustering module 320 performs a clustering algorithm on the text in the provided initial text set 310 to generate a plurality of text clusters including at least one text. A plurality of text for constructing a reference text sets 340 are selected from each text cluster. In some embodiments, the number of texts selected from each text cluster may be determined based on the number of texts included in the plurality of text clusters. The clustering module 320 selects text meeting a preset condition (for example, a distance between the text and the center of the data cluster is less than a distance threshold) based on a distance between each text in each data cluster and the center of the data cluster. The reference text set 340 is constructed based on the selected text.

In some embodiments, the electronic device performs a filtering operation on the reference text set 340 with the data filtering module 330 to remove erroneous text in the reference text set 340. For example, incomplete data in the reference text set 340 (e.g., “generate white dog and”) or unclear text (e.g., generate white) is deleted. The electronic device obtains a reference text set 340 including a plurality of first texts 212 according to the text output by the data filtering module 330.

It is to be understood that the order of the clustering module and the data filtering module shown in FIG. 3 is exemplary only and is not intended to be limiting. Data filtering may also be performed first and then clustered.

Reference is continued to FIG. 2. In some embodiments, the electronic device generates at least one reference image 214 by using the image generation model based on the first text 212 of the first language in the reference text set 340.

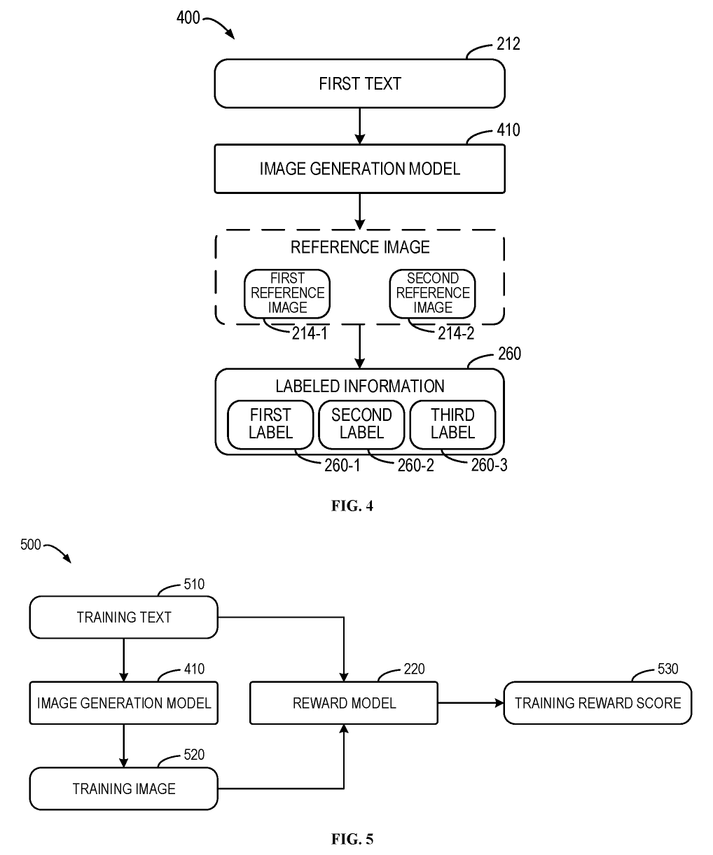

FIG. 4 is an architecture diagram of an example of an labeled information acquisition system 400 according to some embodiments of the present disclosure. As shown in FIG. 4, the electronic device generates a reference image 214 corresponding to each text according to the text in the reference image 214 by using an image generation model 410 (for example, a text generation graph model). In some embodiments, for each first text 212, the image generation model 410 may generate one or more different reference images 214. In the case where multiple different reference images 214 are generated, differences exist between different reference images 214 on different quality metrics.

In some embodiments, labeled information may indicate a plurality of quality metrics. By way of example, the quality metrics may include an image-text matching metric, an image aesthetic metric, and an image structure metric. The image-text matching metric indicates a degree of matching between the first text 212 and the reference image 214. The image aesthetic metric may indicate the aesthetics of the reference image 214. The image structure metric indicates whether the structure of the reference image 214 is reasonable.

Reference is continued to FIG. 2. In some embodiments, the electronic device converts the first text 212 into a second text 213 in the second language that is different from the first language. Subsequently, the electronic device trains the reward model 220 based on the first text 212, the second text 213, the at least one reference image 214, and the labeled information 260 for the at least one reference image 214. The labeled information 260 indicates the image quality of the at least one reference image 214, and the reward model 220 is configured for fine tuning the image generation model 410.

In some embodiments, the labeled information 260 is labeled information 260 of the user for the reference image 214. The labeled information 260 indicates a quality metric. As shown in FIG. 4, the labeled information 260 includes at least first labeled information 260-1, second labeled information 260-2, and third labeled information 260-3, which may be singly or collectively referred to as labeled information 260. For example, the quality index may be an image-text matching metric, an image aesthetic metric, or an image structure metric. In a case where there is only one reference image 214, the labeled information 260 indicates the quality of the reference image 214. For example, the labeled information 260 may indicate a score of the image-text matching metric of the user for the reference image 214, a score of the image aesthetic metric for the reference image 214, or an image structure metric score for the reference image 214.

Where there are multiple reference images 214, the labeled information 260 may be a difference of multiple reference images 214. For example, the plurality of reference images 214 include a first reference image and a second reference image, and the labeled information 260 indicates a reference evaluation of the quality of the first reference image and the second reference image. In some embodiments, if the labeled information 260 indicates an image-text matching metric, the labeled information 260 indicates a relative value (or a priority value) of the image-text matching degree of the first reference image and the image-text matching degree of the second reference image. For example, the labeled information 260 may indicate that the text matching degree of the second reference image is higher than the first reference image.

In some embodiments, the electronic device generates the second text 213 corresponding to the first text 212 and different in language according to the first text 212 in the provided reference text set 340 by using the language model 250. The electronic device generates a first training sample 210 for the first language based on the first text 212, the at least one reference image 214, and the labeled information 260. A second training sample 211 for the first language is generated based on the second text 213, the at least one reference image 214, and the labeled information 260. The reward model 220 is trained by using the first training sample 210 and the second training sample 211.

In some embodiments, for the first text 212 in the reference text set 340, the electronic device generates the first training sample 210 and the second training sample 211 based on the first text 212, the second text 213 corresponding to the first text 212, and the reference image 214. For example, if the first text 212 is a Chinese text and the second text 213 is an English text, the first training sample 210 is a Chinese data pair, and the second training sample 211 is an English data pair.

In some embodiments, the electronic device determines the first reward score 230 using the reward model 220 based on the first text 212, the first reference image, and the second reference image. The first reward score 230 indicates an assessment of the relative image quality of the first reference image and the second reference image with respect to the first language. Subsequently, the electronic device determines the second reward score 240 using the reward model 220 based on the second text 213, the first reference image, and the second reference image. The second reward score 240 indicates an assessment of the relative image quality of the first reference image and the second reference image in the second language. The electronic device updates a parameter of the reward model 220 based on a difference 231 between the first reward score 230 and the labeled information 260 and a difference 241 between the second reward score 240 and the labeled information 260.

In some embodiments, the reward model 220 may be trained based on the labeled information 260 corresponding to all the quality metrics related to the reference image 214.

In order to enable the reward model 220 to more accurately evaluate different quality metrics of the image, thereby improving the training effect of the training image generation model, a plurality of reward models may be used. In other words, the reward model 220 may include a plurality of sub-reward models, and each sub-reward model corresponds to one quality index. For example, a sub-reward model for image-text matching, a sub-reward model for image aesthetics, and a sub-reward model for an image structure may be included. In this way, each sub-reward model learns knowledge of the corresponding quality index aspect to provide corresponding feedback in the process of fine tuning the image generation model 410.

In some embodiments, in the training of the reward model 220, a portion of the parameters of the reward model 220 are variable to preserve a feature representation learned by the pre-trained model on the original task. For example, an adaptive learned to-image contrastive learning (ALT CLIP) model may be used as the reward model 220, and the similarity score output by the ALT CLIP model generally refers to the degree of matching between the text description and the generated image.

In some embodiments, the electronic device may fine-tune the image generation model 410 using the trained reward model 220 to improve the performance of the image generation model 410. FIG. 5 illustrates an architecture diagram 500 of an example of image generation model training according to some embodiments of the present disclosure. As shown in FIG. 5, the electronic device generates the training image 520 by using the image generation model 410 based on a training text 510. Subsequently, the electronic device updates the parameters of the image generation model 410 by using the trained reward model 220 based on a training image 520 and the training text 510.

The style of the image generation model 410 is greatly influenced by the training samples. For example, if the text used to train the image generation model 410 of the image 520 is mostly a sample in a certain language, the image generation model 410 obtained based on these texts is more likely to generate an image of a style corresponding to the language. Therefore, the manner of adding the description text to the training text 510 may be used to adjust the style of the image generated by the image generation model 410.

In some embodiments, the electronic device obtains descriptive text about the target image element in the training image 520. The electronic device then updates the training text 510 by adding the description text to the training text 510. Based on the training image 520 and the updated training text 510, parameters of the image generation model 410 are updated with the trained reward model 220. The description text is used to indicate characteristics of elements in the target image. For example, if a cartoon style image is desired to be generated, the description text may be made to be a “cartoon scene”, so that the image generation model 410 generates a cartoon style image. In this way, the performance of the image generation model 410 is further improved.

In this way, the embodiments of the present disclosure fine-tune the image generation model through the reward model, thereby improving the quality of the images generated by the image generation model in the dimensions such as the image-text matching, the image structure, and the image aesthetics. On the other hand, by adding the description text indicating the style of the image element to the training text, the performance of the image generation model is further improved.

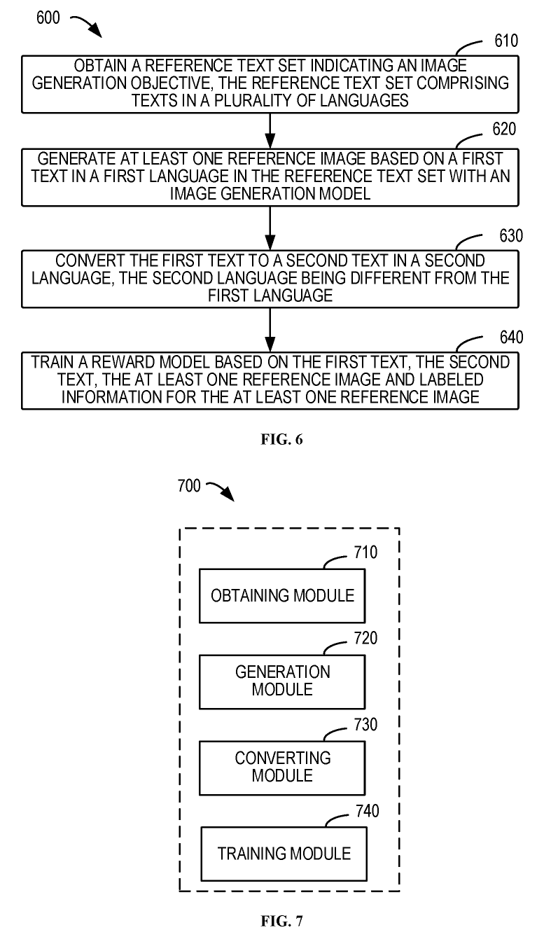

FIG. 6 shows a flowchart of a process for generating an image according to some embodiments of the present disclosure. Process 600 may be implemented or included at electronic device 140.

At block 610, a reference text set indicating an image generation objective is obtained, the reference text set including texts in a plurality of languages.

In some embodiments, the reference text set is obtained by: generating an initial text set based on texts related to image generation in the plurality of languages; determining one or more clusters by performing clustering on the texts in the initial text set, each cluster of the one or more clusters comprising at least one text; and selecting a text from the initial text set based on the one or more clusters to add to the reference text set.

In some embodiments, selecting the text from the initial text set includes, for each cluster of the one or more clusters, selecting the text from the cluster based on distances between texts in the cluster and a center of the cluster.

At block 620, at least one reference image is generated based on a first text in a first language in the reference text set with the image generation model.

At block 630, the first text is converted to a second text in a second language, the second language being different from the first language.

At block 640, a reward model is trained based on the first text, the second text, the at least one reference image, and labeled information for the at least one reference image. The labeled information indicates an image quality of the at least one reference image, and the reward model is configured for fine tuning the image generation model.

In some embodiments, the labeled information indicates a plurality of quality metrics, and the reward model includes a plurality of sub-reward models respectively corresponding to the plurality of quality metrics.

In some embodiments, the plurality of quality metrics include at least one of: an image-text matching metric, an image aesthetic metric, or an image structure metric.

In some embodiments, the at least one reference image includes a first reference image and a second reference image, and the labeled information indicates a reference evaluation of relative image quality of the first reference image and the second reference image.

In some embodiments, training the reward model includes: determining a first reward score based on the first text, the first reference image, and the second reference image with the reward model, the first reward score indicating an evaluation of relative image quality of the first reference image and the second reference image with respect to the first language; determining a second reward score based on the second text, the first reference image, and the second reference image with the reward model, the second reward score indicating an evaluation of relative image quality of the first reference image and the second reference image with respect to the second language; and updating parameters of the reward model based on a difference between the first reward score and the labeled information and a difference between the second reward score and the labeled information.

In some embodiments, training the reward model includes: generating a first training sample for the first language based on the first text, the at least one reference image and the labeled information; generating a second training sample for the first language based on the second text, the at least one reference image and the labeled information; and training the reward model with the first training sample and the second training sample.

In some embodiments, in the training of the reward model, a part of parameters of the reward model are variable.

In some embodiments, the method 600 further includes fine tuning the image generation model by: generating a training image based on a training text with the image generation model; and updating parameters of the image generation model based on the training image and the training text with the trained reward model.

In some embodiments, the updating a parameter of the image generation model based on the training image and the training text includes: obtaining description text about a target image element in the training image; updating the training text by adding the description text to the training text; and updating the parameters of the image generation model based on the training image and the updated training text with the trained reward model ..

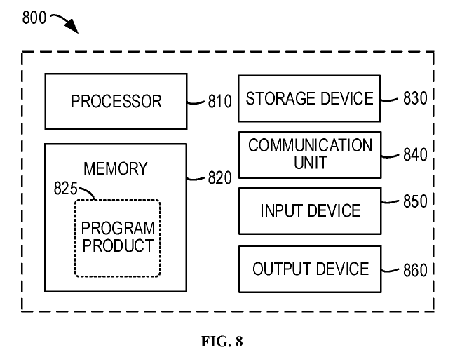

FIG. 7 illustrates a block diagram of an apparatus for generating image generation according to some embodiments of the present disclosure. The apparatus 700 may be implemented or included in the electronic device 140. The various modules / components in the apparatus 700 may be implemented by hardware, software, firmware, or any combination thereof.

As shown in FIG. 7, the apparatus 700 includes an obtaining module 710, configured to obtain a reference text set indicating an image generation objective, where the reference text set includes text in multiple languages. The apparatus 700 further includes a generating module 720 configured to generate at least one reference image by using the image generation model based on the first text in the first language in the reference text set. The apparatus 700 further includes a conversion module 730 configured to convert the first text into a second text in a second language, the second language being different from the first language. The apparatus 700 further includes a training module 740 configured to train a reward model based on the first text, the second text, the at least one reference image, and labeled information for the at least one reference image, where the labeled information indicates an image quality of the at least one reference image, and the reward model is configured to fine tune the image generation model.

In some embodiments, the obtaining module 710 is further configured to an initial text set based on texts related to image generation in the plurality of languages; determine one or more clusters by performing clustering on the texts in the initial text set, each cluster of the one or more clusters comprising at least one text; and select a text from the initial text set based on the one or more clusters to add to the reference text set.

In some embodiments, the obtaining module 710 is further configured to, for each cluster of the one or more clusters, select the text from the cluster based on distances between texts in the cluster and a center of the cluster.

In some embodiments, the labeled information indicates a plurality of quality metrics, and the reward model includes a plurality of sub-reward models respectively corresponding to the plurality of quality metrics.

In some embodiments, the plurality of quality metrics include at least one of: an image-text matching metric, an image aesthetic metric, or an image structure metric.

In some embodiments, the at least one reference image includes a first reference image and a second reference image, and the labeled information indicates a reference evaluation of relative image quality of the first reference image and the second reference image.

In some embodiments, the training module 740 is further configured to determine a first reward score based on the first text, the first reference image, and the second reference image with the reward model, the first reward score indicating an evaluation of relative image quality of the first reference image and the second reference image with respect to the first language; determine a second reward score based on the second text, the first reference image, and the second reference image with the reward model, the second reward score indicating an evaluation of relative image quality of the first reference image and the second reference image with respect to the second language; and update parameters of the reward model based on a difference between the first reward score and the labeled information and a difference between the second reward score and the labeled information.

In some embodiments, the training module 740 is further configured to generate a first training sample for the first language based on the first text, the at least one reference image and the labeled information; generate a second training sample for the first language based on the second text, the at least one reference image and the labeled information; and train the reward model with the first training sample and the second training sample .

In some embodiments, in the training of the reward model, a part of parameters of the reward model are variable.

In some embodiments, the apparatus 700 further includes a fine tuning module configured to generate a training image based on a training text with the image generation model; and update parameters of the image generation model based on the training image and the training text with the trained reward model.

In some embodiments, the fine tuning module is further configured to obtain description text about a target image element in the training image; update the training text by adding the description text to the training text;; and update the parameters of the image generation model based on the training image and the updated training text with the trained reward model.

FIG. 8 shows a block diagram illustrating an electronic device 800 in which one or more embodiments of the present disclosure may be implemented. It may be understood that the electronic device 800 illustrated in FIG. 8 is merely exemplary and may not constitute any limitation on the functionality and scope of the embodiments described herein. The electronic device 800 shown in FIG. 8 may be configured to implement the electronic device 140 and the electronic device 150 in FIG. 1.

As shown in FIG. 8, the electronic device 800 is in the form of a general-purpose electronic device. Components of the electronic device 800 may include, but are not limited to, one or more processors or processing units 810, a memory 820, a storage device 830, one or more communication units 840, one or more input devices 850, and one or more output devices 860. The processor 810 may be an actual or virtual processor and capable of performing various processes according to programs stored in the memory 820. In multiprocessor systems, multiple processors execute computer-executable instructions in parallel to improve parallel processing capabilities of electronic device 800.

Electronic device 800 typically includes a plurality of computer storage media. Such media may be any available media accessible to the electronic device 800, including, but not limited to, volatile and non-volatile media, removable and non-removable media. The memory 820 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 830 may be a removable or non-removable medium and may include a machine-readable medium, such as a flash drive, magnetic disk, or any other medium, which may be capable of storing information and / or data and may be accessed within electronic device 800.

The electronic device 800 may further include additional removable / non-removable, volatile / non-volatile storage media. Although not shown in FIG. 8, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 820 may include a computer program product 825 having one or more program modules configured to perform various methods or actions of various embodiments of the present disclosure.

The communication unit 840 is configured to communicate with another electronic device through a communication medium. Additionally, the functionality of components of the electronic device 800 may be implemented in a single computing cluster or multiple computing machines capable of communicating over a communication connection. Thus, the electronic device 800 may operate in a networked environment using logical connections with one or more other servers, network personal computers (PCs), or another network node.

The input device 850 may be one or more input devices such as a mouse, a keyboard, a trackball, or the like. The output device 860 may be one or more output devices, such as a display, a speaker, a printer, or the like. The electronic device 800 may also communicate with one or more external devices (not shown) through the communication unit 840 as needed, external devices such as storage devices, display devices, etc. , communicate with one or more devices that enable a user to interact with the electronic device 800, or communicate with any device (e.g., a network card, a modem, etc. ) that enables the electronic device 800 to communicate with one or more other electronic devices. Such communication may be performed via an input / output (I / O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and / or block diagrams of methods, apparatuses, devices, and computer program products implemented in accordance with the present disclosure. It may be understood that each block of the flowchart and / or block diagram, and combinations of blocks in the flowcharts and / or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions / acts specified in the flowchart and / or block diagram. These computer-readable program instructions may also be stored in a computer-readable storage medium that cause the computer, programmable data processing apparatus, and / or other devices to function in a particular manner, such that the computer-readable medium storing instructions includes an article of manufacture including instructions to implement aspects of the functions / acts specified in the flowchart and / or block diagram (s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions / acts specified in the flowchart and / or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and / or flowchart, as well as combinations of blocks in the block diagrams and / or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for image generation, comprising:
obtaining a reference text set indicating an image generation objective, the reference text set comprising texts in a plurality of languages;
generating at least one reference image based on a first text in a first language in the reference text set with an image generation model;
converting the first text to a second text in a second language, the second language being different from the first language; and
training a reward model based on the first text, the second text, the at least one reference image and labeled information for the at least one reference image, the labeled information indicating an image quality of the at least one reference image, and the reward model being configured to fine-tunning the image generation model.

2. The method of claim 1, wherein the labeled information indicates a plurality of quality metrics, and the reward model comprises a plurality of sub-reward models respectively corresponding to the plurality of quality metrics.

3. The method of claim 1, wherein the at least one reference image comprises a first reference image and a second reference image, and the labeled information indicates a reference evaluation of relative image quality of the first reference image and the second reference image.

4. The method of claim 1, wherein the reference text set is obtained by:
generating an initial text set based on texts related to image generation in the plurality of languages;
determining one or more clusters by performing clustering on the texts in the initial text set, each cluster of the one or more clusters comprising at least one text; and
selecting a text from the initial text set based on the one or more clusters to add to the reference text set.

5. The method of claim 4, wherein selecting the text from the initial text set comprises:
for each cluster of the one or more clusters, selecting the text from the cluster based on distances between texts in the cluster and a center of the cluster.

6. The method of claim 2, wherein the plurality of quality metrics comprises at least one of:
an image-text matching metric, an image aesthetic metric, or an image structure metric.

7. The method of claim 1, wherein training the reward model comprises:
generating a first training sample for the first language based on the first text, the at least one reference image and the labeled information;
generating a second training sample for the first language based on the second text, the at least one reference image and the labeled information; and
training the reward model with the first training sample and the second training sample.

8. The method of claim 3, wherein training the reward model comprises:
determining a first reward score based on the first text, the first reference image, and the second reference image with the reward model, the first reward score indicating an evaluation of relative image quality of the first reference image and the second reference image with respect to the first language; determining a second reward score based on the second text, the first reference image, and the second reference image with the reward model, the second reward score indicating an evaluation of relative image quality of the first reference image and the second reference image with respect to the second language; and updating parameters of the reward model based on a difference between the first reward score and the labeled information and a difference between the second reward score and the labeled information.

9. The method of claim 1, wherein a part of the parameters of the reward model is variable in the training of the reward model.

10. The method of claim 1, further comprising fine tuning the image generation model by:
generating a training image based on a training text with the image generation model; and updating parameters of the image generation model based on the training image and the training text with the trained reward model.

11. The method of claim 10, wherein updating the parameters of the image generation model based on the training image and the training text comprises:
obtaining description text about a target image element in the training image; updating the training text by adding the description text to the training text; and
updating the parameters of the image generation model based on the training image and the updated training text with the trained reward model.

12. An electronic device, comprising:
at least one processor; and at least one memory coupled to the at least one processor and storing instructions executed by the at least one processor, wherein the instructions, when executed by the at least one processor, cause the electronic device to perform acts comprising:
obtaining a reference text set indicating an image generation objective, the reference text set comprising texts in a plurality of languages; generating at least one reference image based on a first text in a first language in the reference text set with an image generation model; converting the first text to a second text in a second language, the second language being different from the first language; and training a reward model based on the first text, the second text, the at least one reference image and labeled information for the at least one reference image, the labeled information indicating an image quality of the at least one reference image, and the reward model being configured to fine-tunning the image generation model.

13. The device of claim 12, wherein the labeled information indicates a plurality of quality metrics, and the reward model comprises a plurality of sub-reward models respectively corresponding to the plurality of quality metrics.

14. The device of claim 12, wherein the at least one reference image comprises a first reference image and a second reference image, and the labeled information indicates a reference evaluation of relative image quality of the first reference image and the second reference image.

15. The device of claim 12, wherein the reference text set is obtained by:
generating an initial text set based on texts related to image generation in the plurality of languages;
determining one or more clusters by performing clustering on the texts in the initial text set, each cluster of the one or more clusters comprising at least one text; and
selecting a text from the initial text set based on the one or more clusters to add to the reference text set.

16. The device of claim 15, wherein selecting the text from the initial text set comprises:
for each cluster of the one or more clusters, selecting the text from the cluster based on distances between texts in the cluster and a center of the cluster.

17. The device of claim 13, wherein the plurality of quality metrics comprises at least one of:
an image-text matching metric,
an image aesthetic metric, or
an image structure metric.

18. The device of claim 12, wherein training the reward model comprises:
generating a first training sample for the first language based on the first text, the at least one reference image and the labeled information;
generating a second training sample for the first language based on the second text, the at least one reference image and the labeled information; and
training the reward model with the first training sample and the second training sample.

19. The device of claim 14, wherein training the reward model comprises:
determining a first reward score based on the first text, the first reference image, and the second reference image with the reward model, the first reward score indicating an evaluation of relative image quality of the first reference image and the second reference image with respect to the first language; determining a second reward score based on the second text, the first reference image, and the second reference image with the reward model, the second reward score indicating an evaluation of relative image quality of the first reference image and the second reference image with respect to the second language; and updating parameters of the reward model based on a difference between the first reward score and the labeled information and a difference between the second reward score and the labeled information.

20. A non-transitory computer-readable storage medium having a computer program stored thereon, the computer program being executable by a processor to implement acts comprising:
obtaining a reference text set indicating an image generation objective, the reference text set comprising texts in a plurality of languages;
generating at least one reference image based on a first text in a first language in the reference text set with an image generation model;
converting the first text to a second text in a second language, the second language being different from the first language; and
training a reward model based on the first text, the second text, the at least one reference image and labeled information for the at least one reference image, the labeled information indicating an image quality of the at least one reference image, and the reward model being configured to fine-tunning the image generation model.
